(19) United States
(12) Patent Application Publication
(10) Pub. No.: US 2003/0081421 A1
(43) Pub. Date: May 1, 2003

(54) Heat-controlled, multi-bulb, lampshade

(76) Inventors: Paul Eusterbrock, Minneapolis, MN (US); Franz Holtkoetter, Lippstadt (DE)

Correspondence Address: Oppenheimer Wolff & Donnelly LLP, Suite 3300, 45 South Seventh Street, Minneapolis, MN, 55402-1609, US

(21) Appl. No.: 10/037,797

(22) Filed: Oct. 25, 2001

(51) Int. Cl. F21S 8/08

(52) U.S. Cl. 362/414

(57) ABSTRACT

A lampshade for a halogen lighting system includes a housing having at least two light bulb units. Each light bulb unit is rated at a less wattage than the traditional 300 watt halogen bulb and thus operates at a lower temperature. In some embodiments, the lampshade also includes a heat sensor for turning off power to the light bulb units when a threshold temperature is reached. A venting area allows heated air to escape from the lampshade. In some embodiments, a tilt switch offers further safety by turning off the power when the lampshade is moved outside of its proper orientation.

### BACKGROUND OF THE INVENTION

This invention relates generally to lighting systems. Particularly, this invention relates to a lighting system which manages dangerous situations by lowering the top temperature of a lighting unit and incorporating a heat controlled safety feature.

Common halogen torchiere floor lamps are often free-standing lamps with a shallow bowl-shaped lampshade mounted on top of a 6-foot pole and are illuminated by a tubular halogen bulb. FIG. 1 shows one embodiment of a halogen lamp 110. A base 140 connects to a pole 130, which joins to a lampshade 120 housing a halogen light bulb (not shown). The light bulb is commonly rated at 300 watts. A cord 150 supplies the lamp with power. These lamps are designed to direct light upwardly, thus providing indirect lighting for the area (e.g., a particular room or enclosed space).

Such lamps were introduced in the United States in 1983 and have since become very popular lighting systems. However, in August 1997, the U.S. Consumer Product Safety Commission and the halogen lamp industry worked together to recall over 40 million of the lamps which were designed for in-home use. According to Safety Commission, the halogen bulbs in these lamps can cause fires due to the alleged high levels of heat typically generated by these bulbs. Between 1992 and 1997, the Safety Commission was aware of at least 189 fires and 11 deaths from such lamps.

As a result of the safety concerns identified, halogen torchiere lamps have been equipped with a glass bulb shield as well as a glass or wire guard over the glass bulb shield since 1997. These protective measures help to prevent flammable materials from touching the bulb. Regardless, the halogen bulbs are still potentially dangerous and the Safety Commission warns the public to never place the lamp near curtains or other cloth window treatments, and to keep children and pets away from the lamp to reduce the likelihood that the lamp will tipover.

In addition to the guards or shield mentioned above, other safety measure have been contemplated by the industry. For example, tipover switches have been incorporated into the lamp which shuts off power to the bulb if the lamp should fall over.

Furthermore, light sensors have been used to shut off the lamp if greater than expected light intensity is detected (See, e.g., U.S. Pat. No. 5,733,038). As another alternative safety feature, emitter/receiver pairs have been positioned around the bulb to detect the presence of undesired objects. This approach is shown in U.S. Pat. No. 6,196,703 and U.S. Pat. No. 5,921,661, both of which are assigned to the assignee of the present invention.

What is needed in the art is a safer torchiere lamp. To be safer, the lamp should not generate dangerous hotspots that would be potential ignition points. The lamp should also automatically turn off should dangerous conditions exist. Of course, these safety improvements should not result in a lamp that provides less lighting than its predecessors.

### SUMMARY OF THE INVENTION

The risk and danger of fire is minimized in the lamp of the present invention by using lower heat bulbs and including a detection system indicative of dangerous conditions.

A housing for a halogen lighting system includes at least two light bulb units and an integral heat sensor. Each light bulb unit is rated at a lower wattage than the traditional 300-watt halogen bulb and thus operates at a lower temperature.

In some embodiments, the lampshade also includes a heat sensor for turning off power to the light bulb units when a threshold temperature is reached. A venting area allows heated air to escape from the lampshade. Should this venting be blocked, the lighting system will tend to overheat. The heat sensor is capable of detecting this condition and shutting the lamp off. For further safety, a tilt switch can be incorporated to shut off the lamp should it fall over.

### BRIEF DESCRIPTION OF THE DRAWINGS

FIG. 1 is a diagram of a halogen torchiere floor lamp from the prior art.

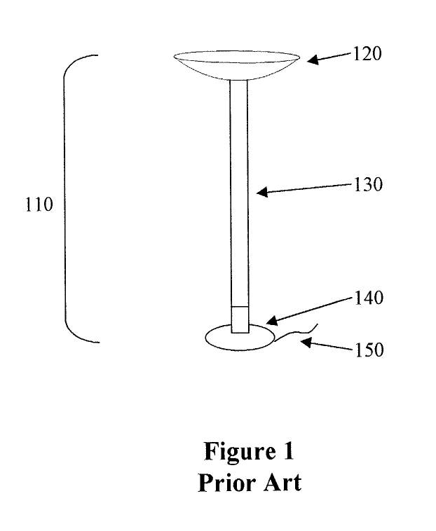

FIG. 2 is a top view of one embodiment of a heat-controlled, multi-bulb lampshade in accordance with the present invention.

FIG. 3A is a top view of a second embodiment of a lighting unit which can be installed within a lampshade in accordance with the present invention.

FIG. 3B is a side perspective view of the second embodiment of a lighting unit which can be installed within a lampshade in accordance with the present invention.

### DETAILED DESCRIPTION OF THE PREFERRED EMBODIMENTS

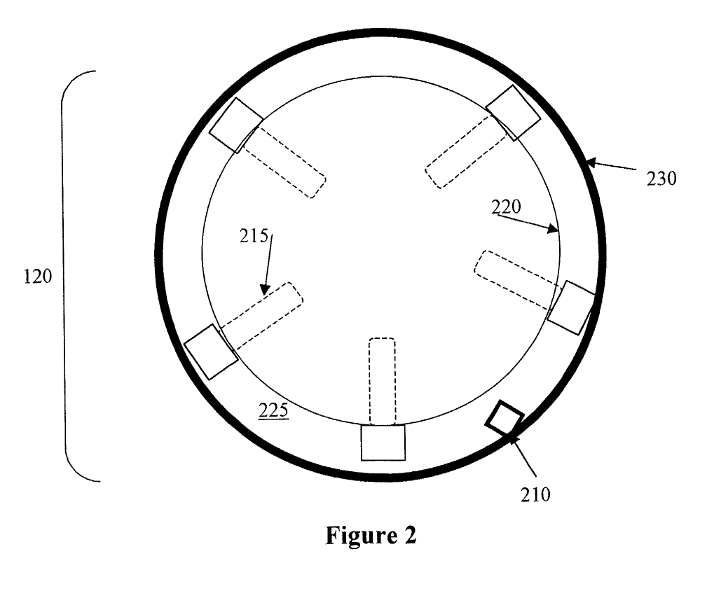

In the following drawings, an attempt has been made to label like elements with the same element number. Referring to FIG. 2, a top view of one embodiment of a heat-controlled, multi-bulb lampshade in accordance with the present invention is shown. The lighting system 120 includes a housing 230 and least one light bulb unit 215. In FIG. 2, five light bulb units 215 are shown distributed around the interior circumference of the housing 230. A shield 220, which may be made of tempered glass or other material, is installed over the top of the light bulb units 215 to inhibit direct contact with the light bulb units 215. A vent area 225 exists between the shield 220 and the edge of the lamp housing 230. A heat sensor 210 is also present. In FIG. 2, the shield 220 is shown as transparent glass and the bulbs of the light bulb units 215 are shown, through the use of dotted lines, to be underneath the shield 220.

In the embodiment shown in FIG. 2, the housing 230 is circular and the shield 220 is also circular, but of a smaller diameter. Thus, the vent area 225 is the difference in area between the housing 230 and shield 220. In other embodiments, the vent area 225 is a series of slots or other configurations that allow venting to occur.

In one embodiment, the light bulb units 215 include the HALOPIN brand halogen bulb manufactured by OSRAM. The HALOPIN bulb is not much larger than a 12 V pin-base lamp and does not need a transformer. For example, some of the bulbs are generally 14 mm wide and 51 mm long. The bulbs are cost-effective, are made from UV-STOP quartz, are fully dimmable, and have an integrated fuse system. Of course, the bulbs made from OSRAM are but one type which can be effectively used in Applicant's invention. Lower-watt light bulbs from other manufacturers can also be used.

As previously discussed, the prior art torchieres commonly use a 300-watt bulb. Such a bulb generates a hot spot on its surface that may be generally 800 degrees Fahrenheit. This extreme temperature is prone to ignite drapes or other materials that come in contact with the bulb. The present invention uses a series of light bulb units 215 of lower wattage, such as provided by the HALOPIN brand bulb. By using five 60-watt bulbs, the lamp of the present invention offers the equivalent wattage as a 300-watt bulb of the prior art. However, as the bulbs are spaced throughout the housing 230, there is no single hot spot that reaches as high of a temperature as the bulb in the prior art. Rather, the hottest spot on a 60-watt bulb is generally only 500 degrees Fahrenheit, which results in a hot spot that is less than 65% as hot as the hot spot of the prior art. The hot spots of the 60-watt bulbs are much less likely to cause ignition of a flammable material and are therefore safer.

Even with the use of bulbs with lower wattage, there is still a concern that heat buildup may cause a fire. This can occur if a portion of lighting system 120 is blocked or covered by a flammable material, such as by a window curtain. The embodiment shown in FIG. 2 includes a second safety feature. The heat sensor 210 turns off the lamp units 215 once a threshold temperature is reached within the lampshade housing 230. Thus, the danger of a curtain blocking the portion of the venting area 225 or of some other cause for heat accumulation is minimized. In one embodiment, the heat sensor is a thermal couple, manufactured by EAW Relaistechnik GmbH, product # SO PEO 16005164.

In some embodiments, a position sensitive switch, or tilt switch, is positioned on the lamp to create an additional safety feature. This switch shuts off power when the lamp is moved from its normal operating position. Specifically, when the switch is moved from its specified orientation (e.g., upright) all power is shut off to the lamp components. This could occur if the lamp was knocked over, if the cord was pulled or tripped over, or any situation where the lamp may fall over. Such a safety feature in shown in U.S. Pat. No. 6,196,703, assigned to the assignee of the present invention, and which is hereby incorporated by reference.

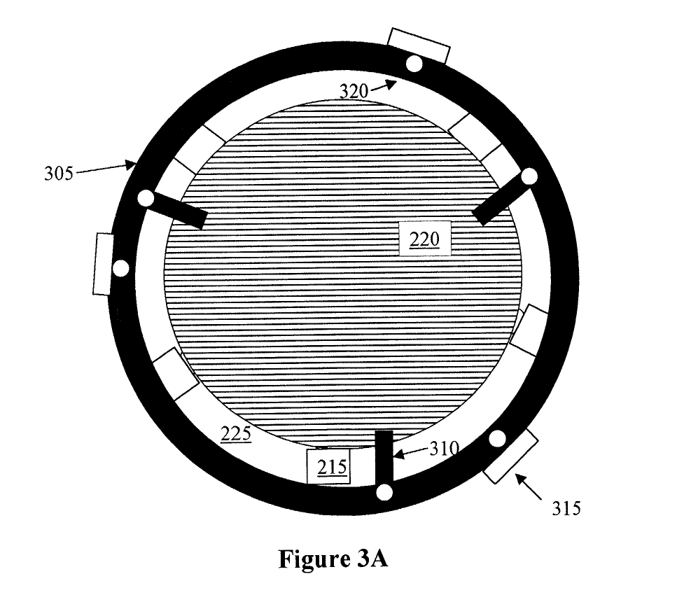

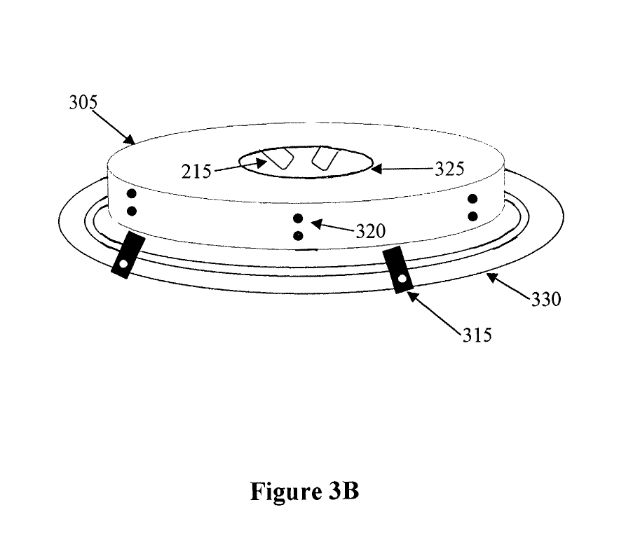

FIGS. 3A and 3B show a second embodiment of the present invention. FIG. 3A is a top view and FIG. 3B is a side perspective view, of a lighting unit 305 which can be installed within a housing 230 in accordance with the present invention. Lighting unit 305 is formed preferably from aluminum or other metal. To the lighting unit 305, shield 220 is attached with the use of shield brackets 310 and screws (or other fastener) 320. Lamp bulb units 215 are also attached using screws (or other fasteners) 320. In FIG. 3A, the shield 220 is shown shaded to indicate frosted glass. Thus, the bulb portion of the lamp bulb units 215 are hidden by shield 220 and are therefore not shown. Lighting unit 305 can be connected to housing 230 through the use of housing brackets 315 or other means. FIG. 3B, a side perspective view of this second embodiment, further shows a second venting area 325 as well as a lip 330 formed around the circumference of the lighting unit 305.

While the specification describes particular embodiments of the present invention, those of ordinary skill can devise variations of the present invention without departing from the inventive concept. For example, the lampshade of the present invention can be of a non-circular shape; the light bulb units can be distributed throughout the housing in a different configuration; and the lampshade can be used for non-torchiere type lamps, such as desk lamps or wall units.

We claim:

1. A lighting system with reduced danger of fire hazard comprising:
a housing;
a plurality of light bulb units spaced within the housing; and
a shield connected to the housing, for inhibiting access to the plurality of light bulb units.

2. The lighting system from claim 1, further comprising a vent area for venting heated air from the housing.

3. The lighting system from claim 1, further comprising a heat sensor placed within the housing, for shutting off the plurality of light bulb units at a threshold temperature.

4. The lighting system from claim 1, wherein the plurality of light bulb units are HALOPIN brand units manufactured by OSRAM.

5. The lighting system of claim 1 wherein the operating temperature of the light bulb unit is generally less than 500° F.

6. The lighting system of claim 1 further comprising a tilt switch for shutting off the plurality of light bulb units when the housing is moved from a specified orientation.
